(19) United States
(12) Patent Application Publication
(10) Pub. No.: US 2010/0064583 A1
(43) Pub. Date: Mar. 18, 2010

(54) Method and apparatus for propagation and growth of plants in a sterile synthetic medium

(75) Inventors: Thomas A. Dundas, Sharpsville, IN (US); Troy L. Burnette, Greentown, IN (US)

Correspondence Address: Frank D. Lachenmaier, 116 N. Main St.,, P.O. Box 1047, Kokomo, IN, 46903-1047, US

(73) Assignee: Syndicate Sales, Inc., Kokomo, IN (US)

(21) Appl. No.: 12/283,968

(22) Filed: Sep. 17, 2008

(51) Int. Cl. A01G 9/02

(52) U.S. Cl. 47/59 S; 47/66.7; 47/87

(57) ABSTRACT

This invention relates generally to a synthetic medium for soilless propagation and growth of plants. More specifically, the synthetic medium components are formed in particular shapes and sizes of a polymer foam to optimize the several stages of plant propagation and growth. A method for utilizing these foam components is also disclosed for use in a standard glass house environment. Each step is optimized for a particular type of plant and its individual growth stage. The soilless medium preferred in this invention also allows for a dramatic reduction in scrap material disposal costs and problems as the preferred foam material reverts to powder form when compressed at up to an 80% volume reduction versus the foam state. These powders can be land-filled, recycled as soil additives or incinerated without environmental impact. Trays for handling foam material components and their lids prevent evaporation of moisture and are also reusable and the thermoplastic resins from which they are formed are also recyclable.

### FIELD OF INVENTION

This invention relates generally to a sterile synthetic medium for the propagation and growth of plants. More specifically, the synthetic growth medium components are formed in particular shapes and sizes of an open cell polymer foam to optimize the several stages of a plant's propagation and growth and minimize scrap material disposal problems. A method for utilizing these components in conjunction with trays in a standard glass house environment is also disclosed.

### BACKGROUND OF INVENTION

Plants and flowers are currently grown in synthetic mediums in greenhouses utilizing several different substrate materials. For a long time the synthetic medium of choice was a mat made from Rockwool or other mineral fibers such as glass wool, or slag wool. These mineral fiber compounds are typically held together with a chemical binder such as a furan. These also use a standard surfactant to assist in water retention. Although these compounds have advantages over soil as a growth medium in their freedom from disease and pests, they also have several significant disadvantages. The disposal of these materials after use has become very problematic. They are no longer accepted in many land fills because of the chemicals that could leach into the surrounding ground water. They can not be pyrolized as they do not burn. Some suppliers are being forced to store their scrap materials on site. Rock wools tend to have a water retention memory such that if a rock wool substrate is under dosed as far as water absorption is concerned, it will never accept more water than the first dosage. Other synthetic materials in use today are open cell polyurethane foams with several different additives. Disposal of these polyurethane foams can also present problems. Although polyurethane foams can be subjected to a pyrolisis process, expensive filtering of pyrolization exhausts and residues can be required depending on the nutrient residues and the amount of nitrogen entrapped in the cellular structure.

### SUMMARY OF INVENTION

The present invention provides a set of components made from a polymer foam that crushes to powder form with up to an 80% volume reduction over the foamed material, dramatically simplifying the disposal of used foam materials and reusable trays made from recyclable thermoplastics.

It also provides a soilless method of growing plants optimized for the various stages of development which dramatically reduces disease growth.

It provides a set of components that work efficiently together with standard glass house irrigation and nutrient feeding systems.

It provides a method of growth encouragement with improved oxygen to media ratios with the air gaps and structural support for the plants at various growth stages.

Still further objects and advantages will become apparent from a consideration of the ensuing description and accompanying drawings. In the description, reference is made to the accompanying drawings which form a part thereof, and in which are shown, by way of illustration, a specific embodiment in which the invention may be practiced. This embodiment will be described in sufficient detail to enable those skilled in the art to practice this invention, and be understood that other embodiments may be utilized and that structural changes may be made without departing from the scope of the invention. In the accompanying drawings, like reference characters designate the same or similar parts throughout the several views.

### DRAWINGS

In order that the invention may be more fully understood it will now be described by way of example, with reference to the accompanying exemplary drawings in which:

FIG. 1 is a top view of a multi-cavity tray;

FIG. 1A is a front elevation view of a multi-cavity tray;

FIG. 1B is an end view of a multi-cavity tray;

FIG. 2 is a top view of a starter plug strip;

FIG. 2A is a front elevation view of a starter plug strip;

FIG. 2B is an end view of a starter plug strip;

FIG. 3 is a top view of a starter plug strip in a multi-cavity tray;

FIG. 3A is a section view of a starter plug strip inserted into a multi-cavity tray taken in the direction of section arrows A-A;

FIG. 3B is a broken perspective view of a rack for supporting multi-cavity trays with 3 of the pockets loaded with trays;

FIG. 4 is an enlarged partial section view of a starter plug strip inserted into a multi-cavity tray;

FIG. 4A is an enlarged partial section view of a starter plug strip inserted into a multi-cavity tray with seedling growing;

FIG. 5 is an enlarged section view of a starter plug with seedling removed from tray and snapped free from strip;

FIG. 6 is a top view of a growth block;

FIG. 6A is a section view of a growth block taken along section arrows A-A;

FIG. 6B a side view of a growth block;

FIG. 7 is a reduced perspective view of a growth slab;

FIG. 8 is a reduced perspective view of a growth slab tray with growth slab tray lid installed;

FIG. 9 is an enlarged section view of a starter plug inserted into a growth block with a seedling growing through the starter plug into the growth block;

FIG. 10 is a broken side view, with partial sections of a growth slab tray with a growth slab tray lid installed, of starter plugs transplanted into growth blocks, transplanted through a growth slab tray lid opening onto a growth slab, located under a plant structural support frame, with plants growing adjacent to a plant irrigation and feeding system. Those standard glass house environs form no part of this invention and are shown in phantom lines.

### REFERENCE NUMERALS

The same reference numbers are used to refer to the same or similar parts in the various views.
12—propagation and growth system
14—seed (not part of this invention)
16—seedling (not part of this invention)
18—plant (not part of this invention)
20—starter plug strip
22—starter plug
24—growth block
26—growth slab
28—plastic block wrap
30—starter plug top surface
32—starter plug bottom surface
34—plant starter opening
36—multi-cavity tray
38—multi-cavity tray drain hole
40—growth block starter pocket
42—growth block top surface
44—growth block bottom surface
46—Growth block side wall
48—Growth slab tray
50—growth slab tray lid
52—growth slab tray lid opening
54—mature plant support frame (not part of this invention)
56—irrigation and nutrient channel (not part of this invention)
58—starter plug lead wall
60—starter plug trailing wall
62—starter plug side walls
64—starter plug joint section
66—growth block starter pocket lead wall
68—growth slab tray lid inside surface
69—growth slab tray lid outside surface
70—growth slab tray inside surface
71—growth slab tray outside surface
72—growth block notch
74—support ledge
76—rack (not part of this invention)
78—starter plug bottom surface lead edge
80—starter plug bottom surface trail edge

### DETAILED DESCRIPTION

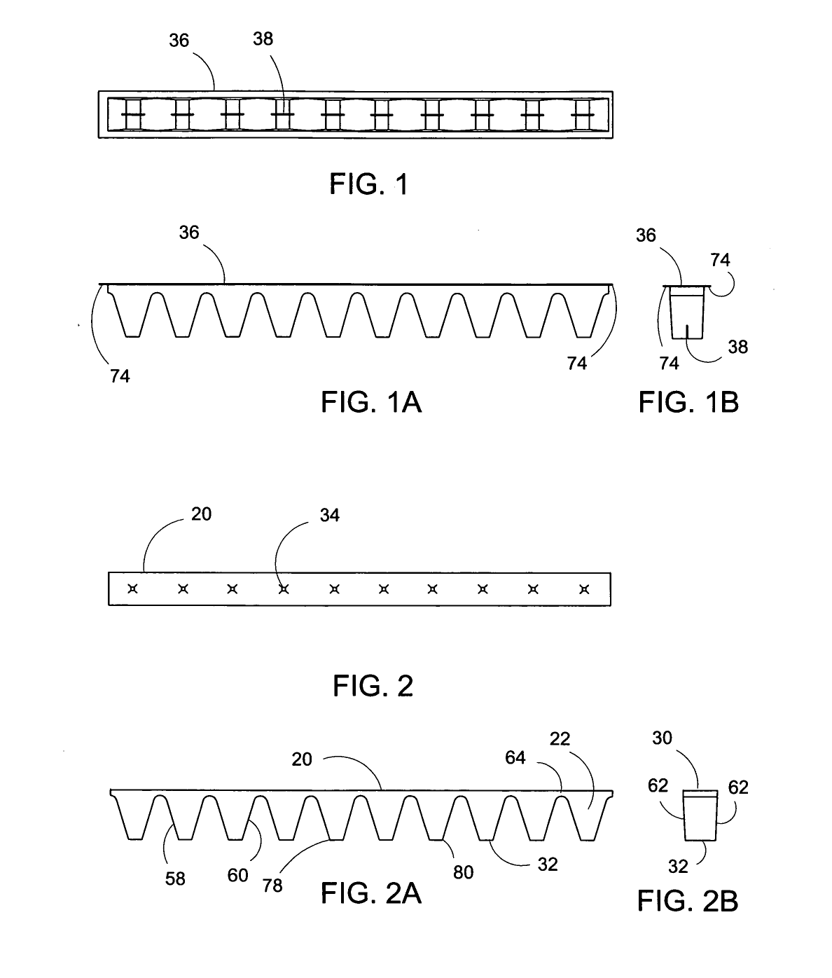

Propagation and growth system 12 is comprised of starter plug strips 20, growth blocks 24 and growth slabs 26 shown in FIGS. 2, 6, and 7 respectively and multi-cavity trays 36 as shown in FIG. 1 and growth slab trays 48 and growth slab tray lids 50 as shown in FIG. 8. Starter plug strips 20, growth blocks 24 and growth slabs 26 are preferably formed from a hydrophilic foam such as AGRIFOAM®, a trademark of applicant. AGRIFOAM® is a combination of Phenolic resin, urea, standard surfactants and standard blowing agents as catalysts to create crushable open cell polymer foam with a preferred density of 1.1 lbs/cu. ft. (plus or minus 0.1 lbs/cu. ft.).

Starter plug strips 20 are separated into individual starter plugs 22 at the appropriate point in the growth process as shown in FIG. 5. Starter plugs 22 have top surfaces 30 that are approximately 1¼×1¼ inches with standard draft side walls 62 that are approximately 2 inches deep connecting to bottom surfaces 32 that are approximately ½ inch long×1⅛ inch wide in one preferred embodiment but dimensions can vary for particular plant types. Starter plugs 22 have lead edges 78 and trail edges 80, and lead walls 58 connecting to bottom surface 32's lead edge 78 and trail walls 60 connecting to bottom surface 32's trail edge 80. Starter plug strips 20 are molded with top surfaces 30 connected between starter plugs 22 with thin joint sections 64 that are approximately ¼ inch thick on approximately 1¾ inch centers. After starter plugs 22 are molded in strips, plant starter openings 34 are punched into the centers of top surfaces 30. FIGS. 1 and 2 show starter plug strips 22 and multi-cavity trays 36 with a 10-up multiple as a working example. The number of plugs 22 and cavities can be modified to match centers with consumer's automatic seeder systems.

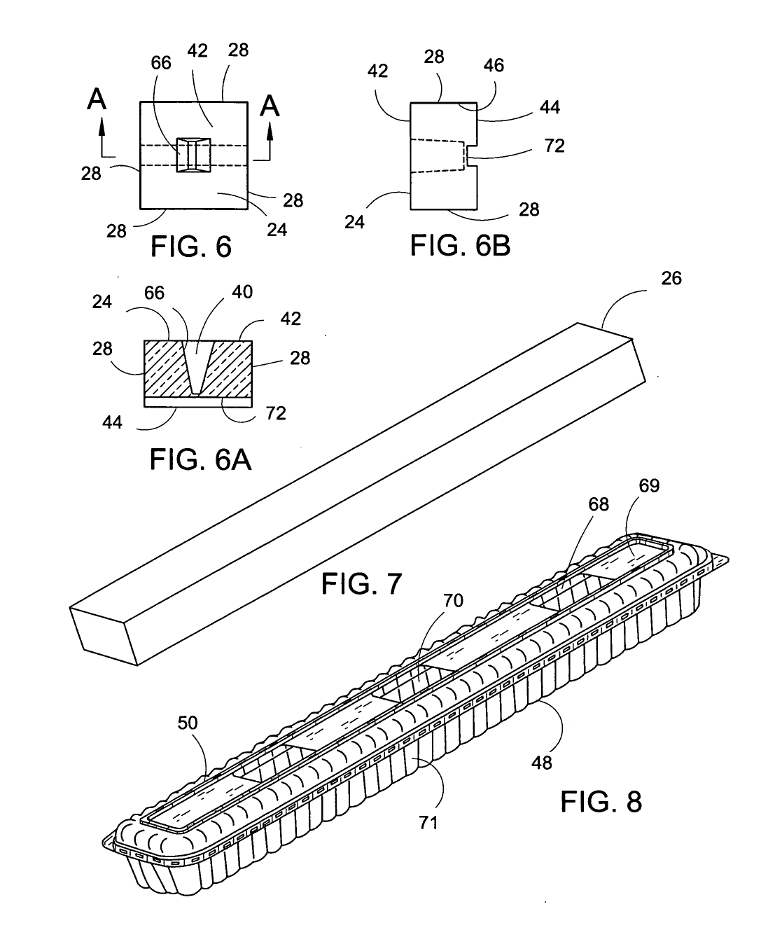

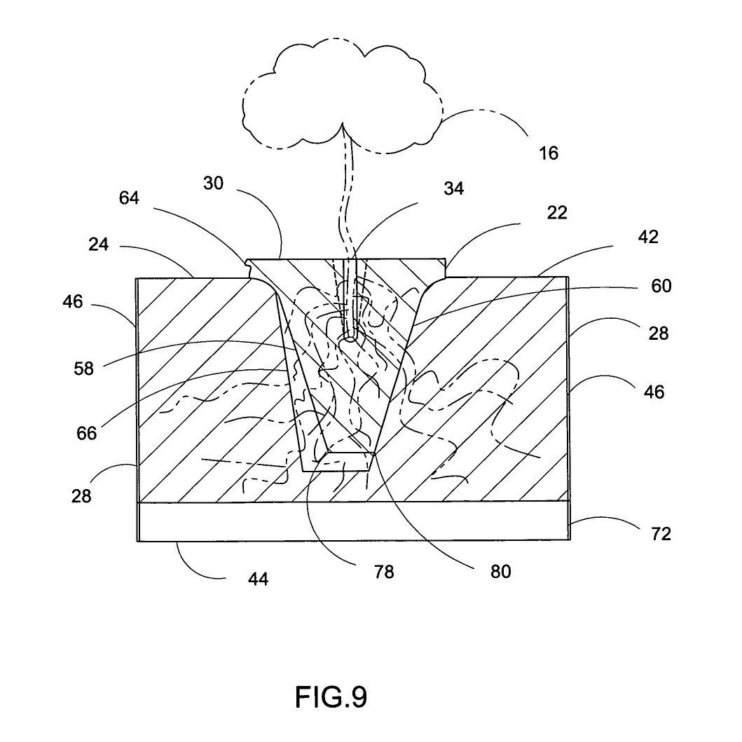

FIG. 6 shows one preferred embodiment of growth blocks 24 that have top surfaces 42 that are approximately 4 inches×4 inches and are approximately 2½ inches deep, dimensions can vary for particular plant types, bottom surfaces 44, side walls 46 with standard draft with growth block starter pockets 40 depending into the center of top surface 42. Growth block starter pocket 40 is a mirror image of starter plug 22 except that growth block starter pocket lead wall 66 is approximately 3 degrees steeper than lead wall 58 on starter block 22 generating an air gap towards the bottom of pocket 40 as shown in FIG. 9. Growth block side walls 46 are encased in a moisture proof thin plastic wrap 28. In one preferred embodiment, bottom surface 44 has at least one notch 72 running the length of block 24 that is approximately ⅜ inch deep×¾ inch wide although particular plant types may prefer more or varying dimension channels.

In FIG. 7 growth slab 26 is shown as an elongated rectangular section of polymer foam that is as long as required for the specific plant 18 selected. One preferred embodiment is a slab 6 inch wide×3 inches deep and 36 inches long, although different dimensions may be alternatively specified for different type of plants. Growth slabs 26 are placed in growth slab trays 48 that are impervious to moisture with growth slab tray lids 50 installed over trays 48. An example of a useful growth slab tray and lid 48 and 50 respectively is shown in FIG. 8 with tray 48 that is approximately 36 inches long×6 inches wide and 3 inches deep which makes a reasonable package in terms of planting, root growth and handling of loaded trays 48, and a matching lid 50 installed that is approximately 6 inches wide, 2 inches deep and 36 inches long with a standard latching feature between the top edge of tray 48 and the rim of lid 50. Different plant types 18 could dictate larger or smaller options when sizing the associated components and trays. Outside surfaces 71 of growth slab tray 48 and outside surfaces 69 of growth slab tray lids 50 are white or light in color to assist in reflecting heat away from growing plants 18. Inside surfaces 70 of growth slab tray 48 and inside surfaces 68 of growth slab tray lid 50 are black or dark in color whereby microbe growth is inhibited. Growth slab tray lid openings 52 are through top surface of growth slab tray lids 50 at the proper spacing with adequate clearance for the plant growth blocks 24 for the specific plant 18 selected. A typical application would have openings for 3 growth blocks 24 in growth slab tray lid 50 equally spaced along its 36 inch length as shown in FIG. 8.

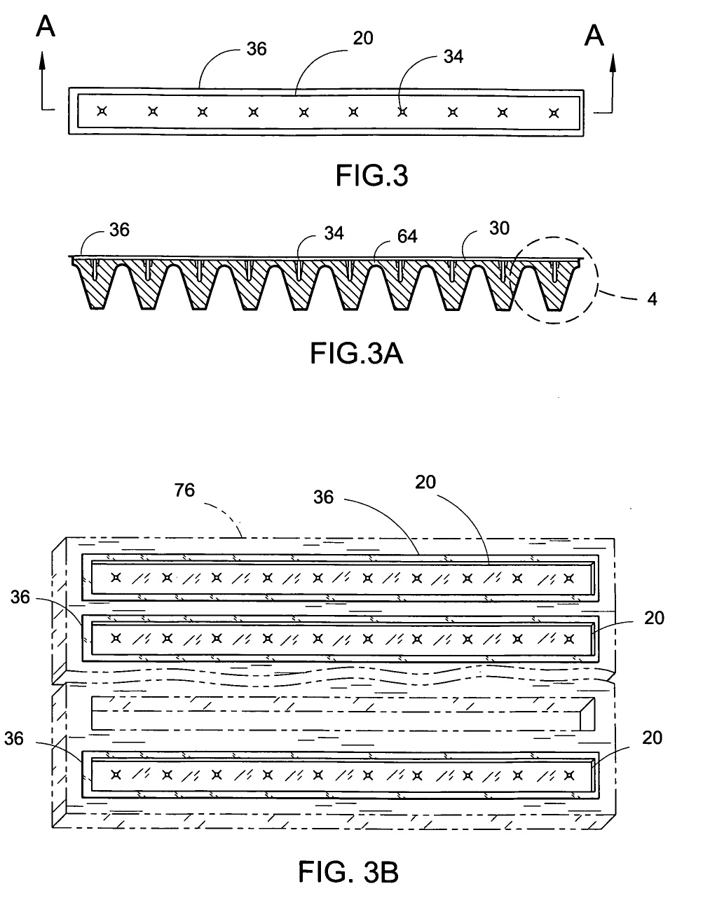

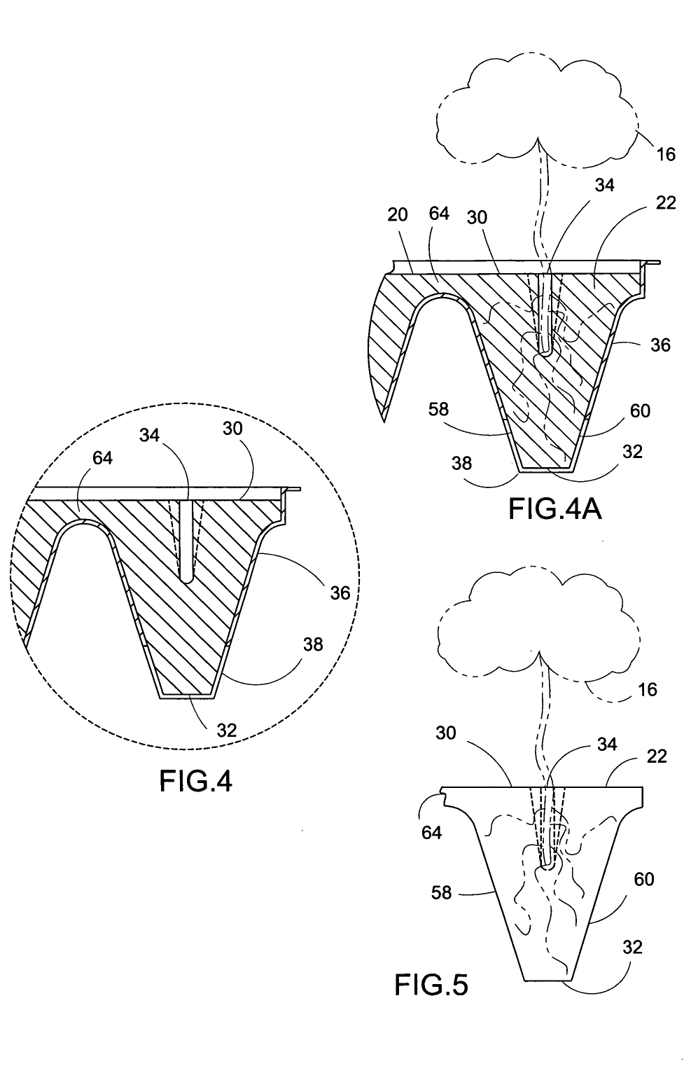

Multi-cavity trays 36 and growth slab trays 48 and growth slab tray lids 50 are produced preferably from a thin wall thermoplastic material such as polyethylene with a vacuum forming process as shown in FIGS. 1 and 8. Multi-cavity trays 36 are the mirror image of the shape of starter plug strips 20 and have drain holes 38 in the bottom of each pocket and a support ledge 74 at the perimeter of the top of multi-cavity tray 36 from which trays may be suspended in racks 76 which form no part of this invention as shown in FIG. 3B for reference only. The thermoplastic resins utilized for trays, 36 and 48 and tray lids 50 are recyclable and reusable also reducing landfill problems.

### Operation

It will be understood that propagation and growth system 12 is intended to provide a sterile soilless medium for plant development that is comprised of components that are made from a crushable polymer foam each optimally sized for a particular stage of development of a particular plant 18. The foam is developed such that plant root structures can mature easily through the foam and it is combined with sufficient surfactants as to absorb and hold moisture adjacent to that developing root structure as to optimize plant 18's growth and yield potential.

The method of utilization of the above described components is illustrated in the following specification. An exemplary process begins with placing starter plug strips 20 into multi-cavity trays 36. Seeds 14 or small seedlings 16 are placed into plant starter openings 34 in starter plug top surface 30 and multi-cavity trays 36 with seeds or seedlings are suspended by their support ledges 74 in racks 76 (not part of this invention) as shown in FIG. 3B within a standard glass house environment with air, water, light and nutrients provided to the developing plants as appropriate to optimize plant development.

When the root structure of seedlings 16 approaches starter plug bottom surface 32, starter plug side walls 62, lead walls 58 and trail walls 60, starter plug strips 20 are removed from multi-cavity trays 36 and broken into individual starter plugs 22 carefully minimizing damage to growing root structures as shown in FIG. 5.

Individual starter plugs 22 with plant roots approaching the exterior walls are transplanted into growth block starter pockets 40 in growth blocks 24. Growth blocks 24 are placed over an irrigation bar that fits into growth block notch 72 in a typical glass house environment and allowed to grow. Growth blocks 24 can have one or more than one groove or notch 72 running across the bottom to improve the oxygen ratio critical to optimize plant growth. The roots breakthrough the exterior walls of starter plug 22 and grow quickly into the air gap between starter plug lead wall 58 of starter plug 22 and growth block starter pocket lead wall 66 and then continue to expand through growth block 24 until the roots reach growth block side walls 46 and growth block bottom surface 44. The air pocket created with the diverging lead walls between starter plugs 22 and growth block starter pocket lead wall 58 also significantly improves the oxygen ratio for the early stage of development.

Growth slabs 26 are then placed into growth slab trays 48 and growth slab tray lids 50 are installed on tray 48. Growth tray lids 50 have openings 52 through which growth blocks 24 with plant roots extending close to the exterior surfaces of growth block 24 are transplanted onto growth slabs 26. Growth blocks slab tray lid openings 52 are spaced along growth slab tray lid 50 with sufficient spacing to optimize the root growth of various plant types.

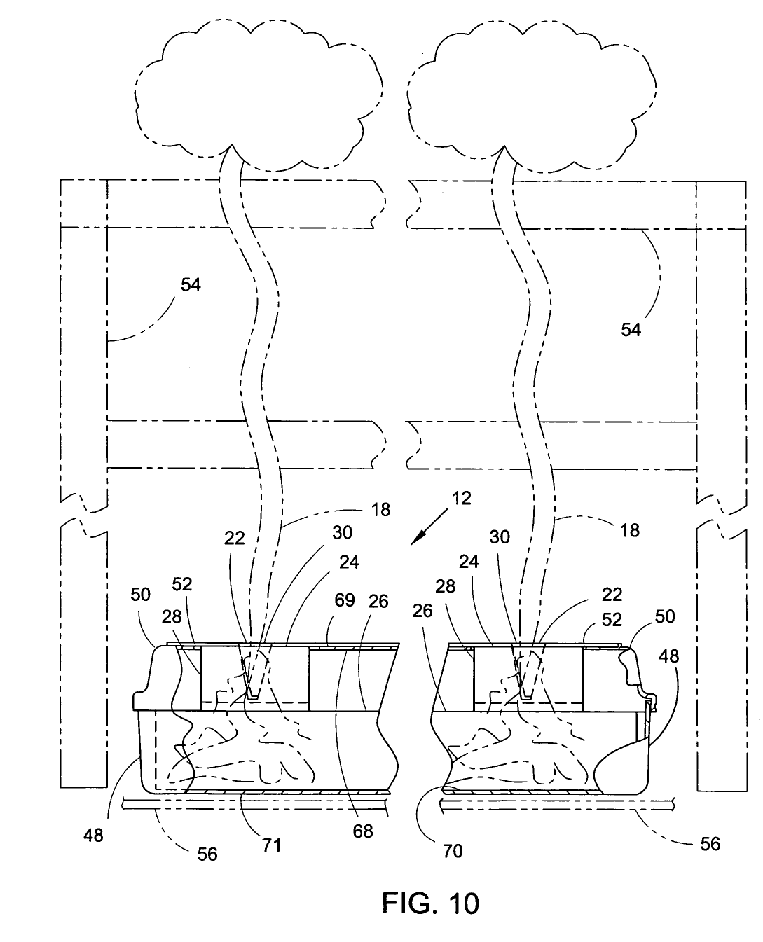

As plants 18 continue to grow and perhaps bear fruit, specific plant support frames 54 are utilized for the several plant types depending on their individual growth or climbing habit. An example of one such support frame 54 is shown in FIG. 10. Support structure 54 is not a part of this invention as it would be obvious to one skilled in these arts as to the support requirements of different plants. The glass house environment and irrigation system 56 are also nursery standard and form no part of this invention.

When plants 18 have matured to point of sale level or to the end of their useful life, plants and roots are cut from the polymer foam and the used foam components can be crushed, reducing their volume by up to 80%, dramatically reducing the scope of the disposal problem. The residual powder can be land-filled, recycled as soil additive, or incinerated without environmental impact. Trays 36 and 48 and tray lids 50 made from thermoplastic materials can also be recycled or reused.

While this invention has been described with reference to illustrative embodiments, it will be understood that this description is not limiting as to size or scale of the components. Persons skilled in these arts can size the various components to optimize the growth experience for various plants with different root system patterns, mature heights and fruit loading. Rather, the scope of this invention is defined by the following claims.

What is claimed is:

1. Apparatus for a soilless plant propagation and growth system, comprising:
starter plug strips with a top surface with a plurality of starter plugs depending from said top surface, connected by front and rear joint sections where said
starter plugs have a top surface with a center, a bottom surface with lead edge and trail edge, side walls, a lead wall, and a trail wall with a plant starter opening in said top surface center and said lead wall angling rearward as said lead wall connects from bottom of said front joint section to said lead edge of said bottom surface and said trail wall angling forward as said trail wall connects from bottom of said rear joint section to said trail edge of said bottom surface where said starter plug strips are constructed with a polymer foam process;
multi-cavity trays with cavities that are mirror images of said starter plug strips such that said starter plug strips fit easily into said multi-cavity trays and with drain holes in the bottom of said tray cavities such that said tray cavities do not trap excess moisture;
growth blocks with a top surface, a bottom surface, side walls, at least one rectangular section notch cut across said bottom surface and a growth block starter pocket depending from and centered in said top surface wherein said pocket with a lead wall has the same shape as said multi-cavity tray cavities except that the angle of said lead wall is steeper than the lead wall of said starter plug thereby creating an air gap that grows larger toward the bottom of said pocket when said starter plug is inserted into said growth block starter pocket whereby an improved oxygen to foam ratio is achieved accelerating root growth, and said growth blocks are constructed with a polymer foam process and wrapped in a thin sheet of thermoplastic material around said side walls whereby evaporation moisture losses are reduced leaving said top and bottom surfaces open to environment; and
growth slabs formed from a polymer foam in long rectangular sections that are housed in
growth slab trays that are impervious to water with an inside surface, an outside surface, and
growth slab tray lids with growth slab tray lid openings at locations spaced along said growth slab tray lid with sufficient clearance to allow placement of said growth blocks with plants growing in them into intimate contact with the top surface of said growth slabs whereby said growth slab trays and said growth slab tray lids act to reduce evaporative losses.

2. Apparatus for a soilless plant propagation and growth system as in claim 1 where said polymer foam utilized in the fabrication of said starter plug strips, said growth blocks and said growth slabs is a combination of Phenolic resin, urea, surfactant and a standard catalyst whereby said polymer foam is crushable with a volume reduction of up to 80% and embodies a cured density of approximately 1.1 lbs/cu. ft.±0.1 lbs/cu. ft. such that penetration of said plant root structure is enhanced and has a consistent open cell structure with no water retention memory.

3. Apparatus for a soilless plant propagation and growth system as in claim 1 where said multi-cavity trays and said growth slab trays and growth slab tray lids are made from a thin wall thermoplastic material.

4. Apparatus for a soilless plant propagation and growth system as in claim 1 where said multi-cavity trays and said growth slab trays and growth slab tray lids inner surfaces are black or dark in color and said outer surfaces are white or light in color, whereby heat is reflected away from growing plants and microbe growth is inhibited within said growth medium

5. A method for soilless plant propagation and growth utilizing the components as described in claim 1 and comprising the steps of:
placing said starter plug strips into said multi-cavity trays whereby said starter plug strips provide a first growing medium;
placing seeds or seedlings into said plant starter openings;
placing said trays with starter plug strips with said seeds or seedlings in a standard rack in a standard glass house environment;
allowing said seeds or seedlings to develop roots systems that approach exterior surfaces of said starter plug strips;
removing said starter plug strips from multi-cavity trays;
carefully separating said starter plug strips into said starter plugs with their individual plants;
transplanting said starter plug with said individual plant into said growth block starter pocket which provides the second growth medium;
placing said growth starter block with growing plant in standard glass house environment and allowing plant root development until said roots begin to approach said exterior sides and said bottom surface of said growth blocks;
placing said growth slabs into said growth slab trays;
soaking said growth slab in standard solutions of water, nutrients and insecticides;
installing said growth slab tray lid onto said growth slab tray where said growth slab tray lid has a plurality of openings spaced along its top surface;
transplanting said growth blocks with said plants onto said growth slabs through said growth slab tray lid openings in a standard glass house environment and beneath standard growth support structures for the type of plant employed where said growth slab provides the final growth medium where said plant completes its growth cycle; and when plant utilization is over
cutting plant and root structure from foam;
land-filling, recycling as soil additive, or incinerating without environmental impact of said foam materials; and
recycling or reusing said multi-cavity trays and said growth slab trays and growth slab tray lids.

6. A method for soilless plant propagation and growth as in claim 5 whereby the polymer foam is a combination of Phenolic resins, urea, surfactants and standard catalysts whereby said polymer foam is crushable with a volume reduction of up to 80% and embodies a cured density of approximately 1.1 lbs/cu. ft. ±0.1 lbs/cu. ft. such that penetration of said plant root structure is enhanced and has a consistent open cell structure with no water retention memory.

7. A method for soilless plant propagation and growth as in claim 5 where said multi-cavity trays, growth slab trays and growth slab tray lids are formed from a thin walled thermoplastic material.

8. A method for soilless plant propagation and growth as in claim 5 where said inner surfaces of said growth slab trays and growth slab tray lids are black or dark in color and said outside surfaces of said growth slab trays and growth slab tray lids are white or light in color whereby microbe growth is inhibited and heat is reflected away from said plants.
